(19) United States
(12) Patent Application Publication
(10) Pub. No.: US 2012/0187781 A1
(43) Pub. Date: Jul. 26, 2012

(54) Motor

(76) Inventors: Yuzuru SUZUKI, (US); Shuhei KINPARA, (US)

(21) Appl. No.: 13/339,103

(22) Filed: Dec. 28, 2011

(30) Foreign Application Priority Data
Jan. 26, 2011 (JP) JP2011-013625

(51) Int. Cl. H02K 5/16

(52) U.S. Cl. 310/43

(57) ABSTRACT

It is an object of this invention to provide a motor with a structure including a bearing only on one side whose assembly accuracy can be easily increased. In a stepping motor including a shaft as a rotating shaft of a rotor and a bearing which rotatably supports the shaft, the bearing is provided only on one side of the shaft, and a one-piece molded member is provided, the one-piece molded member obtained by integrally molding, from resin, the bearing and at least one on the bearing side of a front plate and an end plate.

### BACKGROUND OF THE INVENTION

1. Field of the Invention

The present invention relates to a motor and, more particularly, to a motor which has a characteristic bearing structure.

2. Description of the Related Art

A conventional bearing structure for a motor includes a bearing on both sides, i.e. front side and rear side, in an axial direction, and the two bearings rotatably support a rotating shaft.

In contrast, Japanese Patent Laid-Open No. 06-225510 discloses a structure including a bearing only on one side in an axial direction. Such a one-sided bearing structure (hereinafter also referred to as a “cantilever bearing”) is extended in an axial direction, and a shaft is supported only on one side. The configuration only requires one bearing and allows a reduction in the number of components.

The bearing only on one side disclosed in Japanese Patent Laid-Open No. 06-225510 supports the rotating shaft at its inner peripheral surface and is fixed to a motor case at its outer peripheral surface by being press fit into the motor case or by crimping the motor case onto the bearing.

As described above, in the motor disclosed in Japanese Patent Laid-Open No. 06-225510, the bearing is fixed to the motor case by being press fit into the motor case or by crimping the motor case onto the bearing. Accordingly, when a rotor and a stator are assembled, the rotor may not be accurately positioned with respect to the inner peripheral surfaces of stator yokes.

In the motor disclosed in Japanese Patent Laid-Open No. 06-225510, it is difficult to coaxially align the axis of an output shaft of the motor with the axis of an object to which the motor is attached. For the coaxial alignment, a reference of some kind needs to be provided. This leads to an increase in the number of components and the number of man-hours.

### SUMMARY OF THE INVENTION

The present invention has been made in consideration of the above-described circumstances, and has as its object to provide a motor with a structure including a bearing only on one side whose assembly accuracy can be easily increased.

In order to solve the above-described problems, according to the present invention, there is provided a motor including a shaft as a rotating shaft of a rotor and a bearing which rotatably supports the shaft, wherein the bearing is provided only on one side of the shaft, and a one-piece molded member is provided, the one-piece molded member obtained by integrally molding, from resin, the bearing and at least one on the bearing side of a front plate and an end plate.

According to one embodiment of the present invention, A motor is provided comprising: a shaft as a rotating axis of a rotor; a bearing which rotatably supports said shaft; a stator assembly; a front plate positioned at one end of said stator assembly; and an end plate positioned at another end of said stator assembly, wherein said bearing is integrally molded either with said front plate or with said end plate, preferably from resin.

In this context, the integrally formed bearing and either the front plate or the end plate can be depicted as one-piece molded member, and the front plate which is integrally formed with the bearing can be depicted as a bearing-side plate.

According to another embodiment of the present invention, A motor is provided comprising: a shaft as a rotating axis of a rotor; a bearing which rotatably supports said shaft; a stator assembly; a front plate positioned at one end of said stator assembly; an end plate positioned at another end of said stator assembly; and a reference boss having a through-hole through which said shaft runs, wherein said bearing and said reference boss are integrally molded either with said front plate or with said end plate, preferably from resin, as well as said reference boss is extended in opposite directions from said stator assembly.

According to yet another embodiment of the present invention, in the above context, an inner perimeter of the through-hole is larger than an outer perimeter of the shaft.

According to yet another embodiment of the present invention, in the above context, the integrally molded member above is further integrally molded with the stator assembly, preferably from resin.

According to yet another embodiment of the present invention, in the above context, a length L of the bearing and a diameter D of the shaft preferably satisfy:

2D≦L.

According to yet another embodiment of the present invention, in the above context, the motor further includes a metal bearing between an inner peripheral surface of the bearing and an outer peripheral surface of the shaft.

The present invention has the effects below.

According to one embodiment of the present invention, coincidence of the axis of the inner diameter of a stator in a motor and the axis of the inner diameter of a bearing can be achieved by integral molding. Accordingly, cogging torque caused by an axial misalignment and applied to a shaft of the motor can be inhibited from increasing.

According to another embodiment of the present invention, a rotor is inhibited from being inclined due to an axial misalignment between a front plate and an end plate, which allows a reduction in friction loss.

According to yet another embodiment of the present invention, the process of molding a reference boss integrally with the bearing and the plates allows an increase in assembly accuracy and a reduction in cost. For example, if the present invention is applied to a motor for a meter which rotationally moves a pointer or the like, such as a speedometer of a vehicle, the motor can be directly fixed to a board or an indicator panel of the meter, and the motor can be positioned at the same time as the board or indicator panel. That is, alignment of the center of the reference boss with the center of the shaft is easy, the pointer can be positioned with high accuracy, and the pointer can point accurately.

According to yet another embodiment of the present invention, the process of bringing the length of the shaft within a predetermined range allows accurate positioning of the shaft.

According to yet another embodiment of the present invention, since the coaxiality between the rotor and the stator can be improved, contact of the outer peripheral surface of the rotor with the stator can be easily prevented.

According to yet another embodiment of the present invention, use of a cantilever bearing as the bearing to be attached to the motor allows the side opposite to the bearing in an axial direction to have a flat structure and the motor to be better closed.

In other words, according to the present invention, it is possible to provide a motor with a structure including a bearing only on one side whose assembly accuracy can be easily increased.

### BRIEF DESCRIPTION OF THE DRAWINGS

FIG. 1 is a side sectional view at a rotating shaft position showing a motor according to a first embodiment of the present invention;

FIG. 2 is a side sectional view showing a one-piece molded member which is composed of a bearing 10, a front plate 7, and a reference boss 9 shown in FIG. 1;

FIG. 3 is a side sectional view showing how the stepping motor shown in FIG. 1 is assembled;

FIG. 4 is a side sectional view at a rotating shaft position showing a motor according to a second embodiment of the present invention;

FIG. 5 is a side sectional view at a rotating shaft position showing a motor according to a third embodiment of the present invention; and

FIG. 6 is a side sectional view at a rotating shaft position showing a motor according to a fourth embodiment of the present invention.

FIG. 7 is a side sectional view at a rotating shaft position showing a motor according to a fifth embodiment of the present invention.

### DETAILED DESCRIPTION OF THE PREFERRED EMBODIMENTS

Embodiments of the present invention will be described below with reference to the drawings.

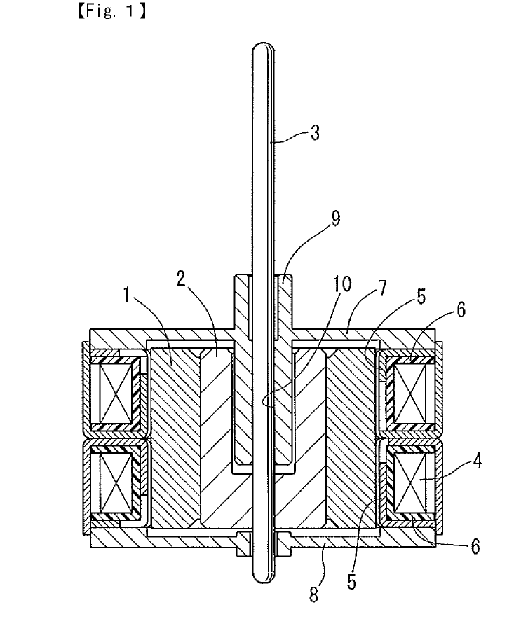

FIG. 1 is a side sectional view at a rotating shaft position showing a motor according to a first embodiment of the present invention. Although the present embodiment will be described in the context of a stepping motor as an example of a motor, the present invention is, of course, also applicable to motors other than stepping motors.

The stepping motor according to the present embodiment can be used as, e.g., an actuator component in a movable part of an indicating instrument such as a speedometer or a tachometer.

The stepping motor includes a rotor which is composed of a shaft 3 as a rotating shaft, a sleeve 2 fixed to the shaft 3, and a rotor magnet 1 fixed to the shaft 3 via the sleeve 2. The stepping motor further includes a stator formed by winding coils 4 around respective stator yokes, each having an inner yoke 5 and an outer yoke 6.

The sleeve 2 need not be made of any particular material and may be made of, e.g., resin or metal.

A reference boss 9 is formed such that, e.g., the axis of a through hole therein and the axis of the outer periphery coincide with each other. The reference boss 9 can be used as a reference for achieving coaxial alignment when the stepping motor according to the present embodiment is to be assembled to, e.g., an external device. An assembly process can be smoothly performed without additional man-hours.

In the present embodiment, a bearing 10 which rotatably supports the shaft 3, a front plate 7 for the motor, and the reference boss 9 protruding outward in an axial direction from the front plate 7 are integrally molded from resin and constitute a one-piece molded member.

Referring to FIG. 1, reference numeral 8 denotes an end plate. The shaft 3 extends through a through hole in the one-piece molded member (the reference boss 9, front plate 7, and bearing 10) and through a through hole in the end plate 8. The through hole of the end plate 8 does not rotatably support the shaft 3, and the shaft 3 is rotatably supported only by the bearing 10.

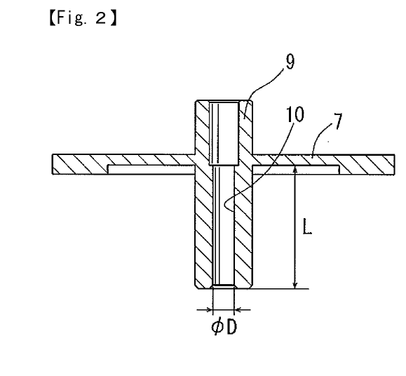

FIG. 2 is a side sectional view showing the one-piece molded member which is composed of the bearing 10, front plate 7, and reference boss 9 shown in FIG. 1.

Note that although the reference boss 9 is also integrated into the one-piece molded member in the present embodiment, the present invention is not limited to this. Only the bearing 10 and front plate 7 may be integrally molded.

As shown in FIG. 2, the bearing 10 has a through hole, which has a length (the effective length of pivotal support) of L (excluding the length of the through hole of the reference boss 9). The length of L is that from an inner side surface of the front plate 9 to an end of the bearing 10. The diameter of the through hole, i.e., the diameter of the shaft 3 is D.

Results of experiments conducted by the present inventors have shown that L and D desirably satisfy the relation 2D≦L. By setting L and D so as to satisfy 2D≦L, sufficiently high coaxial accuracy can be ensured, and the shaft 3 can be rotationally moved with stability by a cantilever bearing.

More specifically, according to the present invention, coincidence of the axis of the inner diameter of the motor stator and the axis of the inner diameter of the bearing can be achieved by integrally molding the bearing 10 and front plate 7. Accordingly, cogging torque caused by an axial misalignment and applied to the shaft of the motor can be inhibited from increasing.

According to the present invention, the rotor is inhibited from being inclined due to an axial misalignment between the front plate 7 and the end plate 8, which allows a reduction in friction loss.

According to the present invention, the process of molding the reference boss 9 integrally with the bearing 10 and front plate 7 allows an increase in assembly accuracy and a reduction in cost. For example, if the present invention is applied to a motor for a meter which rotationally moves a pointer or the like, such as a speedometer of a vehicle, the motor can be directly fixed to a board or an indicator panel of the meter, and the motor can be positioned at the same time as the board or indicator panel. That is, alignment of the center of the reference boss 9 with the center of the shaft 3 is easy, the pointer can be positioned with high accuracy, and the pointer can point accurately.

The process of bringing the length of the shaft 3 within a predetermined range allows accurate positioning of the shaft 3.

Since the coaxiality between the rotor and the stator can be improved, contact of the outer peripheral surface of the rotor with the stator can be easily prevented.

In other words, according to the present invention, it is possible to provide a stepping motor with a structure including a bearing only on one side whose assembly accuracy can be easily increased.

Assembly of the stepping motor according to the present embodiment shown in FIG. 1 will be further described.

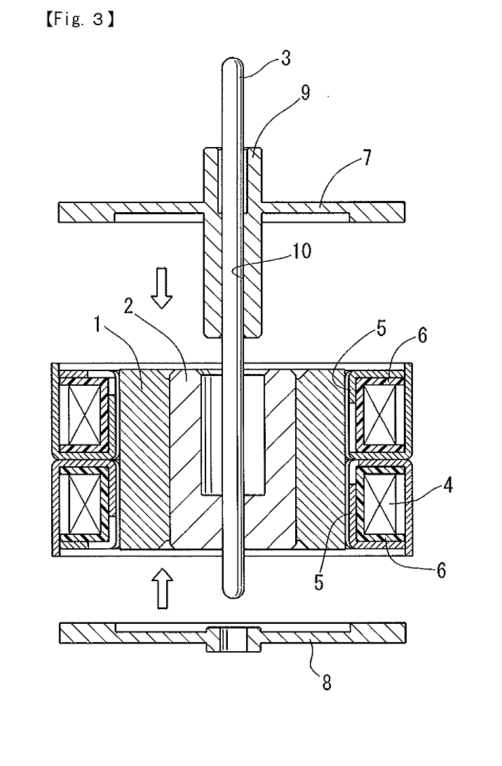

FIG. 3 is a side sectional view showing how the stepping motor shown in FIG. 1 is assembled.

A method for assembling the front plate 7 molded integrally with the bearing 10 and the end plate 8 together is not particularly limited. The assembly can be performed by crimping, bonding, banding, or the like. For example, after the end plate 8 and the stator are integrated into a one-piece structure, the front plate 7 may be assembled to the one-piece structure at the time of insertion of the rotor into the structure, and crimping, banding, or the like may be performed. Alternatively, after the front plate 7 molded integrally with the bearing 10 and the stator are integrated into a one-piece structure, the end plate 8 may be assembled to the one-piece structure at the time of insertion of the rotor into the structure, and crimping, banding, or the like may be performed.

According to the present invention, there is provided a structure that implements a method by which the shaft can be accurately arranged and which requires only a small number of man-hours.

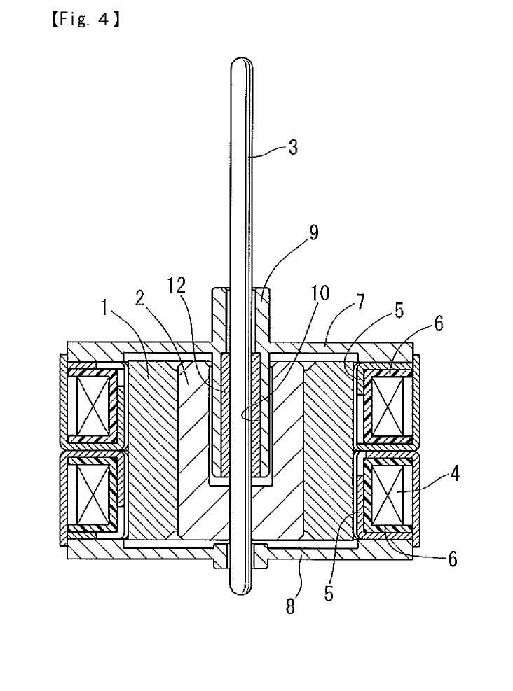

FIG. 4 is a side sectional view at a rotating shaft position showing a motor according to a second embodiment of the present invention.

A stepping motor according to the present embodiment is the same as the stepping motor according to the first embodiment shown in FIG. 1 except that the stepping motor includes a metallic bearing (metal bearing) 12. The same components are denoted by the same reference numerals, and a detailed description thereof will be omitted.

In the present embodiment, as shown in FIG. 4, the metal bearing 12 is fitted into a through hole in a bearing 10 illustrated in FIG. 1, and a through hole in the metal bearing 12 rotatably supports a shaft 3. The process of fitting the metal bearing 12 into the bearing 10 may be performed by integral insert molding, by fixation with adhesive or by press fitting.

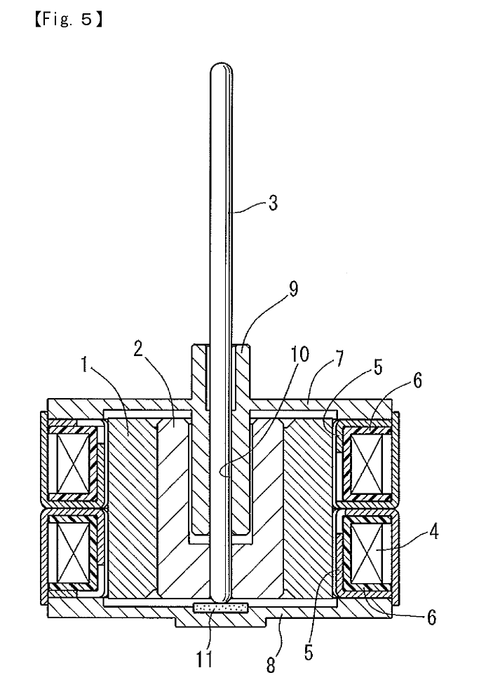

FIG. 5 is a side sectional view at a rotating shaft position showing a motor according to a third embodiment of the present invention.

A stepping motor according to the present embodiment is the same as the stepping motor according to the first embodiment shown in FIG. 1 except that a shaft 3 does not extend through an end plate 8 and that the stepping motor includes a thrust plate 11. The same components are denoted by the same reference numerals, and a detailed description thereof will be omitted.

In the present embodiment, the end plate 8 does not have a through hole through which the shaft 3 extends and has a flat structure. An end on the end plate 8 side of the shaft 3 is in contact with the thrust plate 11, which defines the position of the end in an axial direction.

The present invention adopts a cantilever bearing. Accordingly, in the present embodiment, the side opposite to the bearing in the axial direction can have a flat structure, and the motor can be better closed.

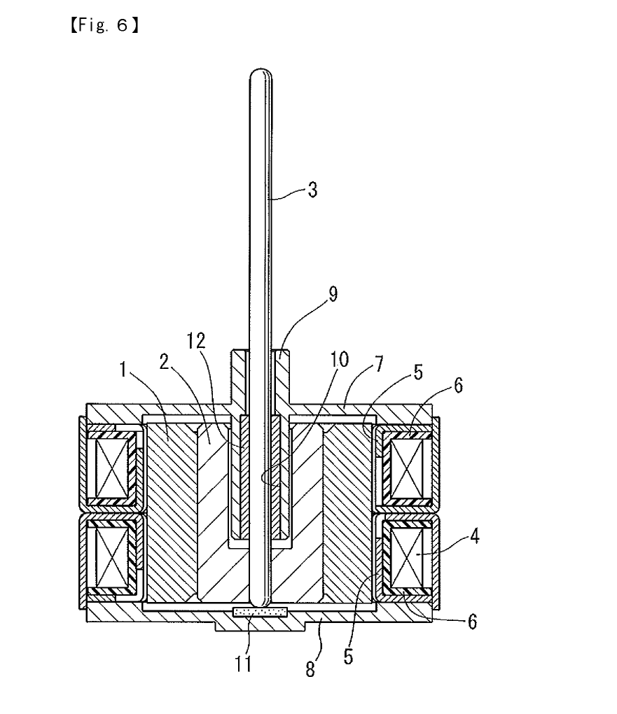

FIG. 6 is a side sectional view at a rotating shaft position showing a motor according to a fourth embodiment of the present invention.

A stepping motor according to the present embodiment is the same as the stepping motor according to the first embodiment shown in FIG. 1 except that the stepping motor includes a metallic bearing (metal bearing) 12, that a shaft 3 does not extend through an end plate 8, and that the stepping motor includes a thrust plate 11. The same components are denoted by the same reference numerals, and a detailed description thereof will be omitted.

That is, the present embodiment is a combination of the second embodiment and the third embodiment and has the advantages of both embodiments.

A motor according to a fifth embodiment of the present invention will be described.

In each of the above-described embodiments, the front plate and the bearing (and optionally the reference boss) are integrally molded. The present invention, however, is not limited to this. Another component may be molded integrally with the components.

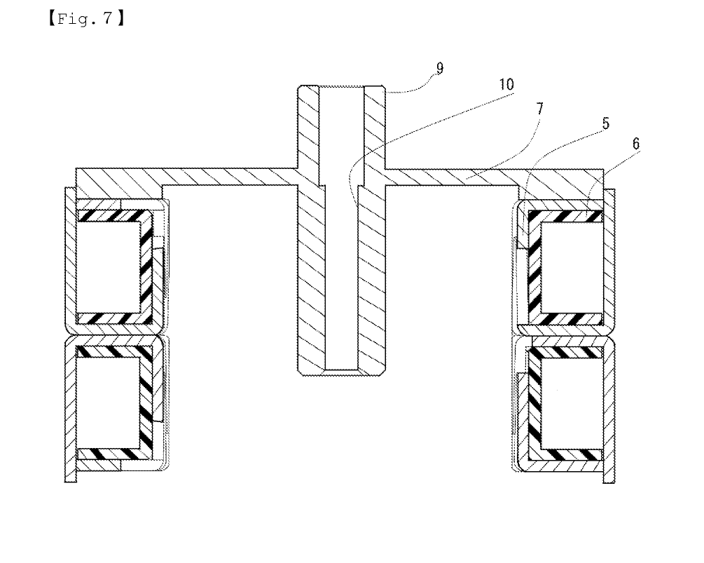

In the fifth embodiment, a stator assembly including stator yokes having inner and outer yokes (in other words, the stator assembly comprises the stator yokes having inner yoke 5 and outer yoke 6) is molded integrally with a front plate and a bearing (and optionally a reference boss), which is shown in FIG. 7. The integral molding can be performed by, e.g., insert molding the front plate and bearing in the stator yokes. In FIG. 7, an opening part between stator's neighboring magnetic poles (cogs) is infilled preferably by resin. It is to be noted that although the stator assembly in FIG. 7 is described in different hatchings and that the border lines among some parts are clearly shown, these parts including the stator assembly should be understood as integrally molded, partly because these description above is adopted for the convenience for discriminating each part like inner yoke 5 or outer yoke 6. Also, the scope of the integrated molded member in the fifth embodiment can include either all hatched area in the FIG. 7 or alternatively a part of the hatched area, for example, the area including the bearing 10, the front plate 7, the reference boss 9, the inner yoke 5, and the outer yoke 6.

The motors according to the present invention have been described above. The present invention is not limited to the description, and various modifications and combinations, of course, may be made without departing from the spirit and scope of the present invention. Also, what is stated above is just an exemplification of embodiment for carrying out the technical idea related to the present invention. It is to be understood that the technical idea related to the present invention can be applied by another embodiment. Also, even if an apparatus, a method, or a system to be generated by use of the present invention are installed on secondary product and commercialized as the product, the value of the present invention can never be deteriorated.
1 rotor magnet
2 sleeve
3 shaft
4 coil
5 inner yoke
6 outer yoke
7 front plate
8 end plate
9 reference boss
10 bearing
11 thrust plate
12 metal bearing

What is claimed is:

1. A motor comprising:
a shaft as a rotating axis of a rotor;
a bearing which rotatably supports said shaft;
a stator assembly;
a front plate positioned at one end of said stator assembly; and
an end plate positioned at another end of said stator assembly,
wherein said bearing is integrally molded either with said front plate or with said end plate.

2. The motor as set forth in claim 1, wherein said bearing and either said front plate or said end plate as the one-piece molded member is formed from resin.

3. The motor as set forth in claim 1, wherein said front plate or said end plate which is integrally molded with said bearing is further integrally molded with said stator assembly.

4. A motor comprising:
a shaft as a rotating axis of a rotor;
a bearing which rotatably supports said shaft;
a stator assembly;
a front plate positioned at one end of said stator assembly;
an end plate positioned at another end of said stator assembly; and
a reference boss having a through-hole through which said shaft runs,
wherein said bearing and said reference boss are integrally molded either with said front plate or with said end plate, as well as said reference boss is extended in opposite directions from said stator assembly.

5. The motor as set forth in claim 4, wherein said bearing and said reference boss and either said front plate or said end plate as the one-piece molded member is formed from resin.

6. The motor as set forth in claim 4, wherein said front plate or said end plate which is integrally molded with said bearing and said reference boss is further integrally molded with said stator assembly.

7. The motor as set forth in claim 4, wherein an inner perimeter of said through-hole is larger than an outer perimeter of said shaft.

8. The motor as set forth in claim 1, wherein a length L of said bearing and a diameter D of said shaft satisfy:
2D≦L.

9. The motor as set forth in claim 4, wherein a length L of said bearing and a diameter D of said shaft satisfy:
2D≦L.

10. The motor as set forth in claim 1, further comprising a metal bearing between an inner peripheral surface of said bearing and an outer peripheral surface of said shaft.

11. The motor as set forth in claim 4, further comprising a metal bearing between an inner peripheral surface of said bearing and an outer peripheral surface of said shaft.
